(19) United States
(12) Patent Application Publication
(10) Pub. No.: US 2015/0350738 A1
(43) Pub. Date: Dec. 3, 2015

(54) BROADCAST PROGRAM PLAYBACK SYSTEM, BROADCAST PROGRAM PLAYBACK DEVICE, AND TERMINAL DEVICE

(71) Applicant: SHARP KABUSHIKI KAISHA, Osaka-shi, Osaka (JP)

(72) Inventors: Ryosuke OHMAE, Osaka-shi (JP); Kazuma NAITO, Osaka-shi (JP); Yohichi EGUCHI, Osaka-shi (JP); Takahiro OGASAWARA, Osaka-shi (JP)

(73) Assignee: SHARP KABUSHIKI KAISHA, Osaka-shi, Osaka (JP)

(21) Appl. No.: 14/653,953

(22) PCT Filed: Dec. 4, 2013
(86) PCT No.: PCT/JP2013/082596

§ 371 Date: Jun. 19, 2015

(30) Foreign Application Priority Data
Dec. 25, 2012 (JP) 2012-281731
Aug. 27, 2013 (JP) 2013-176065

(51) Int. Cl. H04N 21/472; H04N 21/482; H04N 21/4725

(52) U.S. Cl. CPC H04N 21/47217; H04N 21/4725; H04N 21/4828

(57) ABSTRACT

A broadcast program playback system (1) includes: a television (10) for simultaneously displaying a broadcast program and a video identical to a video displayed on an entire part of a screen of a smartphone (20); and a smartphone (20) which includes a display information acquiring section (22) for acquiring predetermined display information in accordance with program information received from the television (10) and which displays the predetermined display information in a format allowing a user to make selection.

### TECHNICAL FIELD

The present invention relates to a broadcast program playback system including (i) a broadcast program playback device that receives and displays a broadcast program and (ii) a terminal device.

### BACKGROUND ART

Along with the recent prevalence of terminal devices such as smartphones and tablets, an increasing number of users use, while viewing a broadcast program that has been received by a television receiver, a terminal device to look up information on the Internet which information is related to the broadcast program.

Patent Literature 1 discloses a television system including: a television receiver that (i) extracts, of all data information corresponding to a TV program, data information matching a request made on a mobile-phone end and then (ii) transmits the data information to a mobile phone; and a mobile phone that (i) displays a list of the data information transmitted from the television receiver, (ii) receives, from the television receiver, data information on the list which data information was selected by the user, and (iii) displays the data information thus received.

### CITATION LIST

### Patent Literature

Patent Literature 1

Japanese Patent Application Publication, Tokukai, No. 2008-312159 (Publication Date: Dec. 25, 2008)

### SUMMARY OF INVENTION

### Technical Problem

However, according to the conventional technique described above, viewing of information concerning a broadcast program displayed on a television receiver requires checking both (i) a screen of a terminal device on which the information concerning the broadcast program is displayed and (ii) a screen of the television receiver on which the broadcast program is displayed. This causes a user to move his/her point of sight a large number of times.

In addition, in a case where information concerning a broadcast program is acquired by a terminal device, such inconvenience arises that, for example, a character string to be searched for needs to be inputted into the terminal device.

The present invention has been made in view of the problems, and it is an object of the present invention to realize a broadcast program playback system that saves a user the inconvenience of operation by simultaneously providing the user with a broadcast program and with information concerning the broadcast program.

### Solution to Problem

In order to attain the object, a broadcast program playback system in accordance with an aspect of the present invention includes: a broadcast program playback device for receiving and displaying a broadcast program; and a terminal device, the broadcast program playback device including a program information acquiring section for acquiring program information concerning the broadcast program, a program information transmitting section for transmitting, to the terminal device, at least part of the program information, a video receiving section for receiving a video transmitted from the terminal device, and a displaying section for simultaneously displaying the broadcast program and the video, and the terminal device including a video transmitting section for transmitting, to the broadcast program playback device, the video identical to a video displayed on an entire part of a screen of the terminal device, a program information receiving section for receiving the program information transmitted from the broadcast program playback device, a display information acquiring section for acquiring predetermined display information in accordance with the program information, and a display information displaying section for displaying, on the screen, the predetermined display information in a format allowing a user to make selection.

Additional objects, features, and strengths of the present invention will be made clear by the description below. Furthermore, the advantages of the present invention will be evident from the following explanation with reference to the drawings.

### Advantageous Effects of Invention

According to a broadcast program playback system according to an aspect of the present invention, it is possible to bring about an effect of saving a user inconvenience by simultaneously providing the user with a broadcast program and information concerning the broadcast program.

### BRIEF DESCRIPTION OF DRAWINGS

FIG. 1 is a block diagram illustrating a configuration of a broadcast program playback system in accordance with Embodiment 1 of the present invention.

FIG. 2 is a flow chart illustrating a flow of a process of displaying a search result carried out by a broadcast program playback system in accordance with Embodiment 1 of the present invention, the broadcast program playback system being configured such that a television simultaneously displays a broadcast program and a video which has been transmitted from a smartphone.

FIG. 3 is a set of views (a) through (c) illustrating screens of functions included in a link application, (a) of FIG. 3 illustrating a number-based channel selection function page, (b) of FIG. 3 illustrating a vertical channel selection function page, and (c) of FIG. 3 illustrating a device selection function page.

FIG. 4 is a view illustrating a display screen of the smartphone in accordance with Embodiment 1 of the present invention.

FIG. 5 is a view illustrating display screens of the television and of the smartphone in accordance with Embodiment 1 of the present invention, which display screens display keywords.

FIG. 6 is a view illustrating display screens of the television and of the smartphone in accordance with Embodiment 1 of the present invention, which display screens display a search history.

FIG. 7 is a block diagram illustrating a configuration of a broadcast program playback system in accordance with Embodiment 2 of the present invention.

FIG. 8 is a flow chart illustrating a flow of a process of displaying an official website carried out by a broadcast program playback system in accordance with Embodiment 2 of the present invention, the broadcast program playback system being configured such that a television simultaneously displays a broadcast program and a video which has been transmitted from a smartphone.

FIG. 9 is a view illustrating display screens of the television and of the smartphone in accordance with Embodiment 2 of the present invention, which display screens display home page information.

FIG. 10 is a flow chart illustrating a flow of a process of displaying a search result carried out by a broadcast program playback system in accordance with Embodiment 3 of the present invention, the broadcast program playback system being configured such that a television simultaneously displays a broadcast program and a video which has been transmitted from a smartphone.

FIG. 11 is a flow chart of a process of displaying an official website carried out by the broadcast program playback system in accordance with Embodiment 3 of the present invention, the broadcast program playback system being configured such that the television simultaneously displays a broadcast program and a video which has been transmitted from the smartphone.

### DESCRIPTION OF EMBODIMENTS

### Embodiment 1

The following description will discuss embodiments of the present invention in detail.

(Configuration of Broadcast Program Playback System)

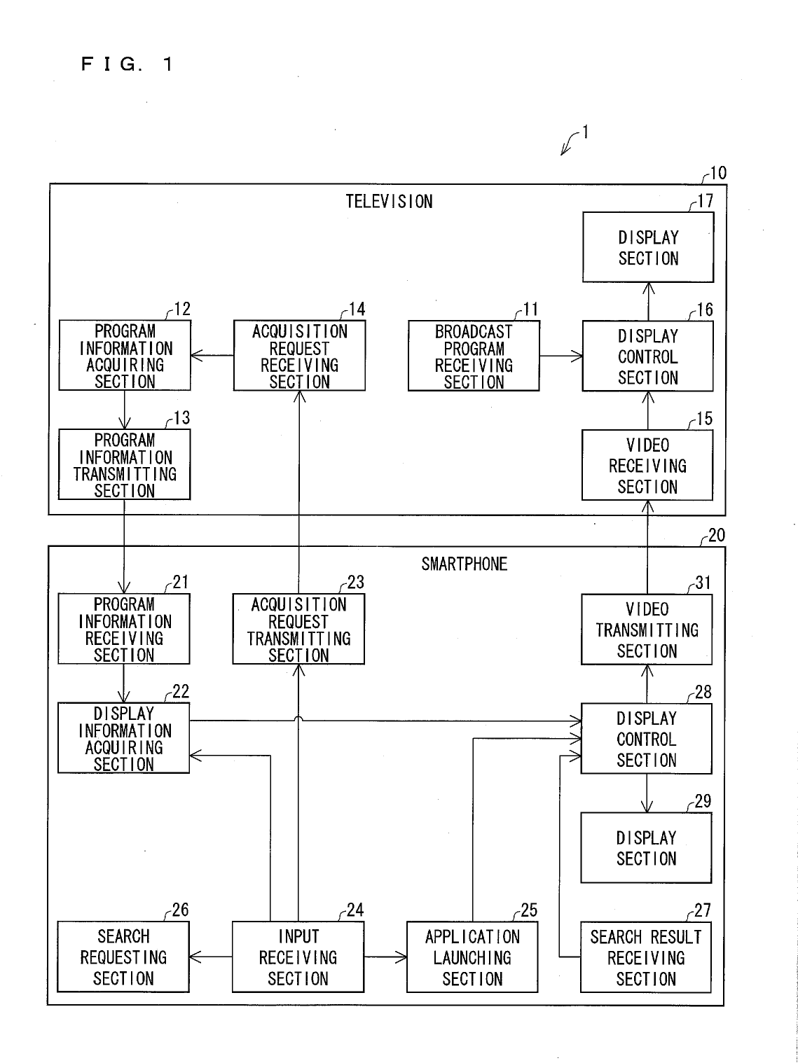

A broadcast program playback system in accordance with an embodiment of the present invention will be described below with reference to FIG. 1. FIG. 1 is a block diagram illustrating a configuration of a broadcast program playback system 1 in accordance with an embodiment (Embodiment 1) of the present invention.

As illustrated in FIG. 1, the broadcast program playback system 1 includes (i) a television receiver (hereinafter referred to as “television”) (broadcast program playback device) 10 for receiving and displaying a broadcast program and (ii) a smartphone (terminal device) 20. The smartphone 20 wirelessly communicates with the television 10 to operate the television 10. A technology used for the wireless communication between the smartphone 20 and the television 10 is, for example, Miracast (registered trademark), but is not limited as such. Alternatively, the smartphone 20 and the television 10 can communicate with each other via wired communication.

Although Embodiment 1 discusses a broadcast program playback device by use of a television as an example, the present invention is not limited as such. For example, the broadcast program playback device can be a PC monitor or the like. In addition, although Embodiment 1 discusses a terminal device by use of a smartphone as an example, the present invention is not limited as such. For example, the terminal device can be a PDA (Personal Digital Assistant) or the like.

Furthermore, the block diagram shown in FIG. 1 depicts, of all functions of the television 10 and of the smartphone 20, functions that are unique to the present invention. Needless to say, the television 10 and the smartphone 20 are equipped with functions that are not illustrated in FIG. 1.

(Configuration of Television 10)

As illustrated in FIG. 1, the television 10 includes a broadcast program receiving section 11, a program information acquiring section 12, a program information transmitting section 13, an acquisition request receiving section 14, a video receiving section 15, a display control section (displaying section) 16 and a display section 17.

The broadcast program receiving section 11 receives, via an antenna, a broadcast program of digital terrestrial broadcasting, BS broadcasting or CS broadcasting. Then, the broadcast program receiving section 11 supplies, to the display control section 16, the broadcast program thus received.

The program information acquiring section 12 acquires, via the antenna, program information concerning the broadcast program received by the broadcast program receiving section 11. Then, the program information acquiring section 12 supplies, to the program information transmitting section 13, the program information thus acquired.

The program information transmitting section 13 transmits, to the smartphone 20, at least part of the program information acquired by the program information acquiring section 12.

The acquisition request receiving section 14 receives an acquisition request (program information acquisition request) which (i) is transmitted from the smartphone 20 and (ii) requests acquisition of program information. Then, the acquisition request receiving section 14 requests the program information acquiring section 12 to acquire program information.

Specific operations of the program information acquiring section 12, the program information transmitting section 13 and the acquisition request receiving section 14 will be described later in detail with the use of a flow chart.

The video receiving section 15 receives a video transmitted from the smartphone 20. Then, the video receiving section 15 supplies, to the display control section 16, the video thus received.

The display control section 16 causes the display section 17 to simultaneously display (i) the broadcast program acquired by the broadcast program receiving section 11 and (ii) the video received by the video receiving section 15.

The display section 17 is a display device that is controlled by the display control section 16 to simultaneously display the broadcast program and the video. Examples of the display section 17 encompass a liquid crystal display, an organic EL (Electro Luminescence) display, and a plasma display.

(Configuration of Smartphone 20)

The smartphone 20 includes a program information receiving section 21, a display information acquiring section 22, an acquisition request transmitting section 23, an input receiving section 24, an application launching section 25, a search requesting section 26, a search result receiving section 27, a display control section (display information displaying section, search result displaying section) 28, a display section (display information displaying section, search result displaying section) 29 and a video transmitting section 31.

The program information receiving section 21 receives the program information transmitted from the television 10. Then, the program information receiving section 21 supplies, to the display information acquiring section 22, the program information thus received.

In accordance with the program information received by the program information receiving section 21, the display information acquiring section 22 acquires predetermined display information. Specifically, in a case where (i) the program information transmitting section 13 of the television 10 transmits, as at least part of the program information acquired by the program information acquiring section 12, a keyword concerning the broadcast program and (ii) the program information receiving section 21 receives the keyword, the display information acquiring section 22 acquires the keyword as display information. In a case where program information received by the program information receiving section 21 is at least part of the program information acquired by the program information acquiring section 12 of the television 10, the display information acquiring section 22 acquires at least one keyword which is contained in the program information received by the program information receiving section 21 and which concerns the broadcast program. Then, the display information acquiring section 22 supplies, to the display control section 28, the display information thus acquired.

The acquisition request transmitting section 23 transmits a program information acquisition request to the television 10 in accordance with an input signal transmitted from the input receiving section 24.

The input receiving section 24 is an input device for receiving an input from a user. The input receiving section 24 is, for example, a touch panel that is stacked on a surface of the display section 29 so as to be integrated with the display section 29. Note that the input receiving section 24 is not limited to a touch panel, but can be a button or the like for receiving an input from the user.

The input receiving section 24 transmits, to the display information acquiring section 22, the acquisition request transmitting section 23, the application launching section 25, or the search requesting section 26, a signal (input signal) that indicates content of the input thus received (in a case where, for example, the input receiving section 24 is a touch panel, the content is what user operation was executed with respect to which one of GUI (Graphical User Interface) elements displayed on the touch panel).

In accordance with the input signal transmitted from the input receiving section 24, the application launching section 25 launches an application. Then, the application launching section 25 supplies, to the display control section 28, a display screen of the application thus launched.

In accordance with the input signal transmitted from the input receiving section 24, the search requesting section 26 requests a search server to carry out search in accordance with the keyword selected by the user.

The search result receiving section 27 receives a search result provided by the search server, and then supplies, to the display control section 28, the search result thus received.

The display control section 28 causes the display section 29 to display, in a format allowing a user to make selection (hereinafter referred to as “user-selectable format”), the display information acquired by the display information acquiring section 22. The display control section 28 also causes the display section 29 to display the search result supplied from the search result receiving section 27. The display control section 28 also causes the display section 29 to display the display screen of the application, which display screen has been supplied from the application launching section 25.

In addition, the display control section 28 supplies, to the video transmitting section 31, a video identical to a video which is to be displayed on an entire screen of the display section 29.

The display section 29 is a display device that is controlled by the display control section 28 to display, on the screen thereof, a video, a search result or the like. Examples of the display section 29 encompass a liquid crystal display, an organic EL (Electro Luminescence) display, and a plasma display.

The video transmitting section 31 transmits, to the television 10, the video which (i) has been supplied from the display control section 28 and (ii) is identical to the video displayed on the entire screen of the display section 29.

(Flow of Process)

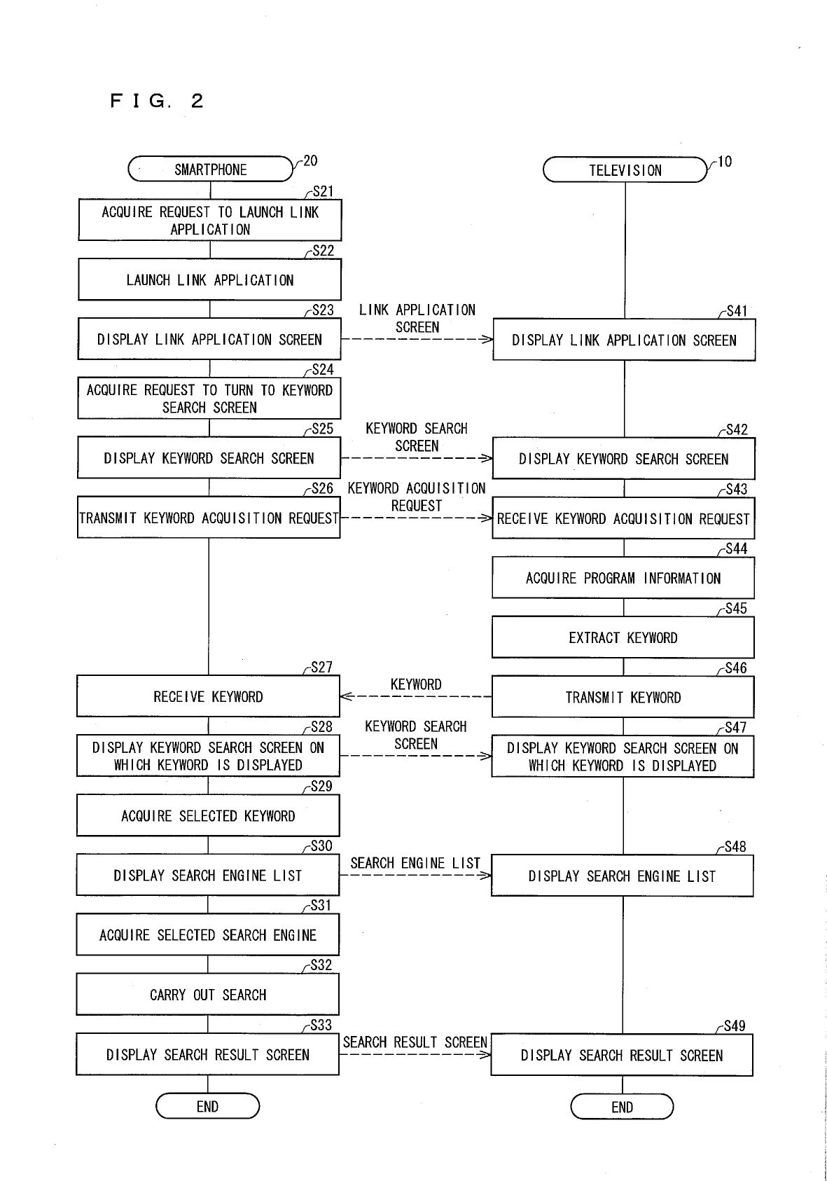

A flow of a process carried out by the broadcast program playback system 1 will be described next with reference to FIG. 2. FIG. 2 is a flow chart illustrating a flow of a process of displaying a search result carried out by the broadcast program playback system 1 in which the television 10 simultaneously displays (i) a broadcast program and (ii) a video transmitted from the smartphone 20. Note that each of broken lines shown between the respective processes of the television 10 and of the smartphone 20 in FIG. 2 indicates transmission of information from the television 10 to the smartphone 20 or vice versa.

Note also that FIG. 2 shows, as information transmitted from the smartphone 20 to the television 10, screens (e.g. link application screen) displayed on the display section 29 of the smartphone 20. In addition to such screens shown in FIG. 2, however, the smartphone 20 transmits, to the television 10, videos identical to videos displayed on the entire screen of the display section 29.

As illustrated in FIG. 2, in a case where a user gives an request to launch a link application while the television 10 is simultaneously displaying a broadcast program and a video which has been transmitted from the smartphone 20, the input receiving section 24 of the smartphone 20 acquires the request (step S21; hereinafter referred to simply as “S21”).

Then, the input receiving section 24 supplies, to the application launching section 25, an input signal indicating that the request to launch the link application has been acquired. Then, the application launching section 25 launches the link application (S22).

The description of the link application is as follows. The link application is an application which (i) is installed in the smartphone 20 and (ii) combines a set of functions for controlling, by use of an IP, a device (i.e. television 10 in Embodiment 1) to which the smartphone 20 is connected. The screen of the smartphone 20 displays pages of functions (function page) of the link application, one page at a time. The function pages to be displayed on the screen can be switched from one function page to another by tapping a tab (switching tab) intended for switching between the functions or by making a flicking gesture on a function page being displayed.

Although Embodiment 1 discusses a keyword search function as an example of the functions of the link application, the functions of the link application are not limited to the keyword search function. For example, the functions of the link application can include a function to display an official webpage.

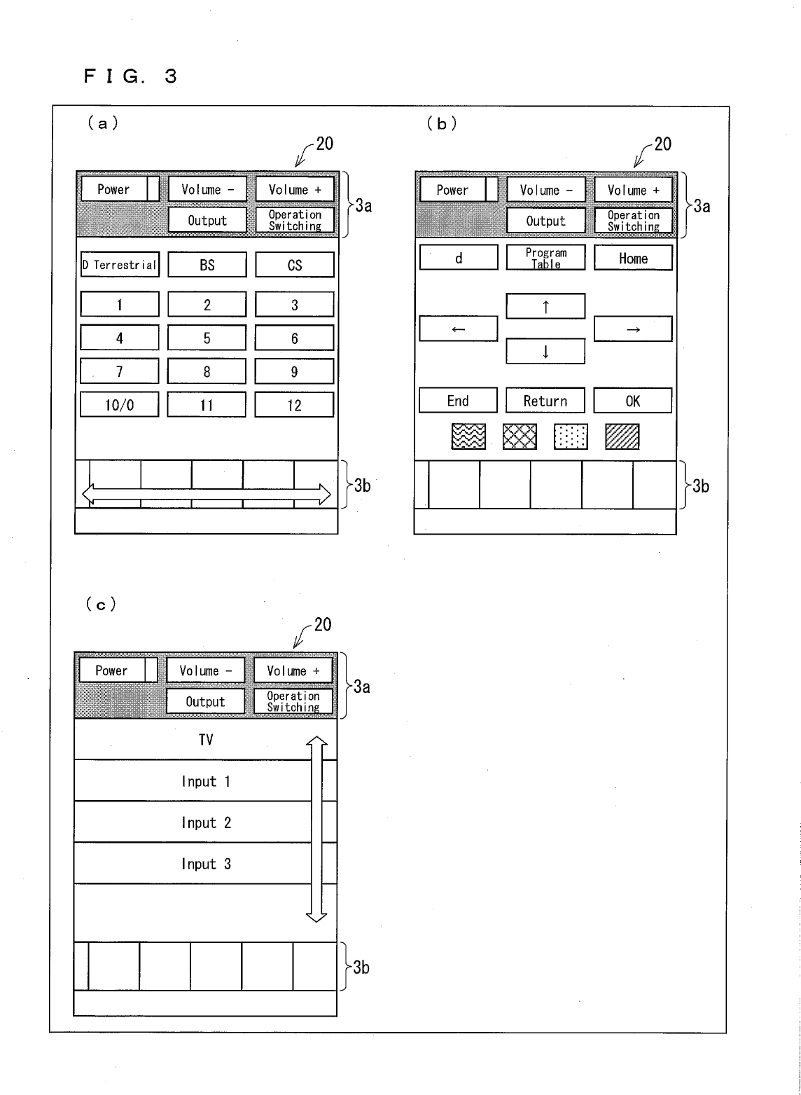

An example of the functions of the link application will be described below with reference to FIG. 3. FIG. 3 is a set of views illustrating screens of the functions included in the link application. (a) of FIG. 3 illustrates a number-based channel selection function page, (b) of FIG. 3 illustrates a vertical channel selection function page, and (c) of FIG. 3 illustrates a device selection function page. As illustrated in (a) through (c) of FIG. 3, an upper part of the screen of the smartphone 20 displays a fixed operation panel 3a, and a lower part of the screen of the smartphone 20 displays a function switching tab 3b. The fixed operation panel 3a and the function switching tab 3b are each a fixed GUI that continues to be displayed on the screen while the link application is running. On the other hand, a middle part of the screen displays either (i) a function page selected by use of the function switching tab 3b or (ii) a function page to which switching is carried out by making a flicking gesture on the screen.

As illustrated in FIG. 3, the fixed operation panel 3a includes a power supply switch, a sound volume down button, a sound volume up button, an external output button, an operation switching button and the like. The power supply switch button is a button for switching between an on state and an off state of a power supply of the television 10. The sound volume down button is a button for lowering a sound volume of the television 10. The sound volume up button is a button for increasing the sound volume of the television 10. The external output button is a button for causing another device (e.g. television 10) to display the screen of the smartphone 20. The operation switching button is a button for switching from the link application screen to a screen of another application or to another operation screen. Note that buttons included in the fixed operation panel 3a are not limited to these buttons, but the fixed operation panel 3a can further include buttons for executing other operations. In addition, the buttons displayed on the fixed operation panel may be changed depending on a status of the smartphone 20. For example, the external output button may not be displayed in a case where the screen of the smartphone 20 is outputted to an external device (e.g. television 10).

The function switching tab 3b is a tab for switching between function pages displayed on the middle part of the screen as described above. As illustrated in (a) through (c) of FIG. 3, the function switching tab 3b is partitioned into a plurality of regions corresponding to respective function pages that can be displayed on the middle part of the screen. For example, in a case where a region located to the farthest left is tapped, (i) the region is highlighted and (ii) a function page corresponding to the region is displayed on the middle part of the screen.

The link application can be permanently installed in the smartphone 20. In addition, a shortcut or the like of the link application can be registered in a launcher or a notification area so that a user can easily launch the link application.

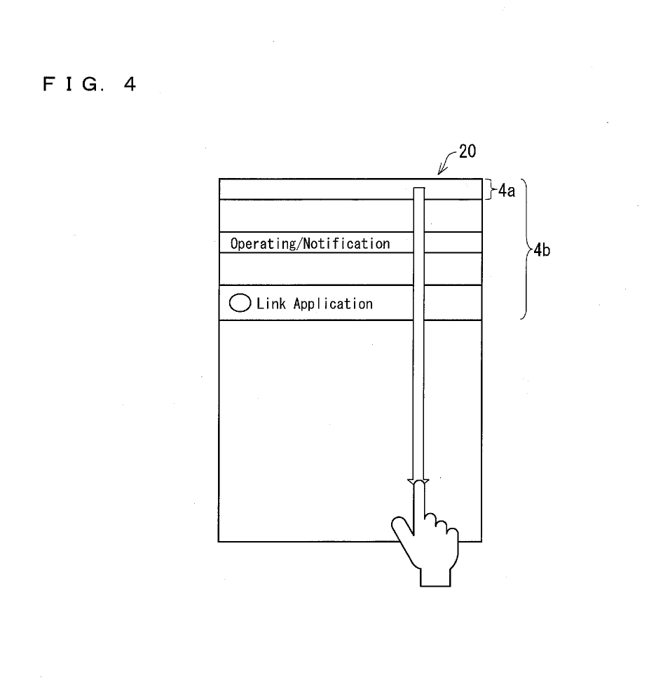

The notification area will be described below with reference to FIG. 4. The notification area is an information notification area located on the screen of the smartphone 20. FIG. 4 is a view illustrating the display screen of the smartphone 20. As illustrated in FIG. 4, the screen of the smartphone 20 displays a notification area 4a. Although the notification area 4a is displayed on the upper part of the screen of the smartphone 20 in FIG. 4, a location at which the notification area 4a is to be displayed is not limited to the upper part. The notification area 4a illustrated in FIG. 4 can be fully displayed by the user's operation to pull the notification area 4a from the upper part.

In FIG. 4, the notification, which has been pulled by the user's operation, is indicated as a notification 4b. The notification 4b displays information on the link application. The smartphone 20 launches the link application in response to the user selecting the information on the link application, which information is displayed on the notification 4b.

The description of the flow of the process of displaying a search result carried out by the broadcast program playback system 1 will be continued below with reference to FIG. 2. When the application launching section 25 launches the link application, the display control section 28 causes the display section 29 to display a function page (link application screen) such as those illustrated in FIGS. 3 and 4 (S23). The display control section 28 also supplies, to the video transmitting section 31, a screen identical to the link application screen displayed on the display section 29. Then, the video transmitting section 31 transmits the screen to the television 10.

When the video receiving section 15 of the television 10 receives the link application screen, the display control section 16 causes the display section 17 to display the broadcast program and the link application screen (S41). Then, in a case where the user gives a turning request to turn to a page showing, of all the functions of the link application, a keyword search function (keyword search screen), the input receiving section 24 of the smartphone 20 acquires the turning request to turn to the keyword search screen (S24). Then, the input receiving section 24 transmits, to the application launching section 25 and to the acquisition request transmitting section 23, an input signal indicating that the turning request to turn to the keyword search screen has been acquired.

Then, the application launching section 25 supplies, to the display control section 28, the keyword search screen as a display screen of the application. Then, the display control section 28 causes the display section 29 to display the keyword search screen thus supplied (S25). The display control section 28 also supplies, to the video transmitting section 31, a screen identical to the keyword search screen displayed on the display section 29. Then, the video transmitting section 31 transmits the screen to the television 10. Then, when the video receiving section 15 of the television 10 receives the keyword search screen, the display control section 16 causes the display section 17 to display the broadcast program and the keyword search screen (S42).

When the acquisition request transmitting section 23 receives the input signal transmitted from the input receiving section 24, the acquisition request transmitting section 23 transmits a program information acquisition request to the television 10. Specifically, the acquisition request transmitting section 23 transmits, as a program information acquisition request, an acquisition request to acquire a keyword(s) contained in program information (keyword acquisition request) (S26).

When the acquisition request receiving section 14 of the television 10 receives the keyword acquisition request (S43), the acquisition request receiving section 14 gives, to the program information acquiring section 12, a notification that the keyword acquisition request has been received. When the program information acquiring section 12 receives the notification, the program information acquiring section 12 acquires program information concerning the broadcast program which has been received by the broadcast program receiving section 11 (S44).

Then, the program information transmitting section 13 extracts, from the program information acquired by the program information acquiring section 12 in the step S44, keywords such as program name, person's name, place name, broadcast station, and URL of the broadcast station (S45), and then transmits the keywords to the smartphone 20 (S46). Note that the keywords are not limited to these examples.

Then, the program information receiving section 21 of the smartphone 20 receives the keywords transmitted from the television 10 (S27). Then, the display information acquiring section 22 acquires, as display information, the keywords received by the program information receiving section 21, and then supplies the keywords to the display control section 28. Then, the display control section 28 causes the display section 29 to display a keyword search screen which displays the supplied keywords in a user-selectable format (S28). The display control section 28 also supplies, to the video transmitting section 31, a screen identical to the screen displayed on the display section 29. Then, the video transmitting section 31 transmits the screen to the television 10.

When the video receiving section 15 of the television 10 receives the keyword search screen, the display control section 16 causes the display section 17 to display the broadcast program and the keyword search screen (S47).

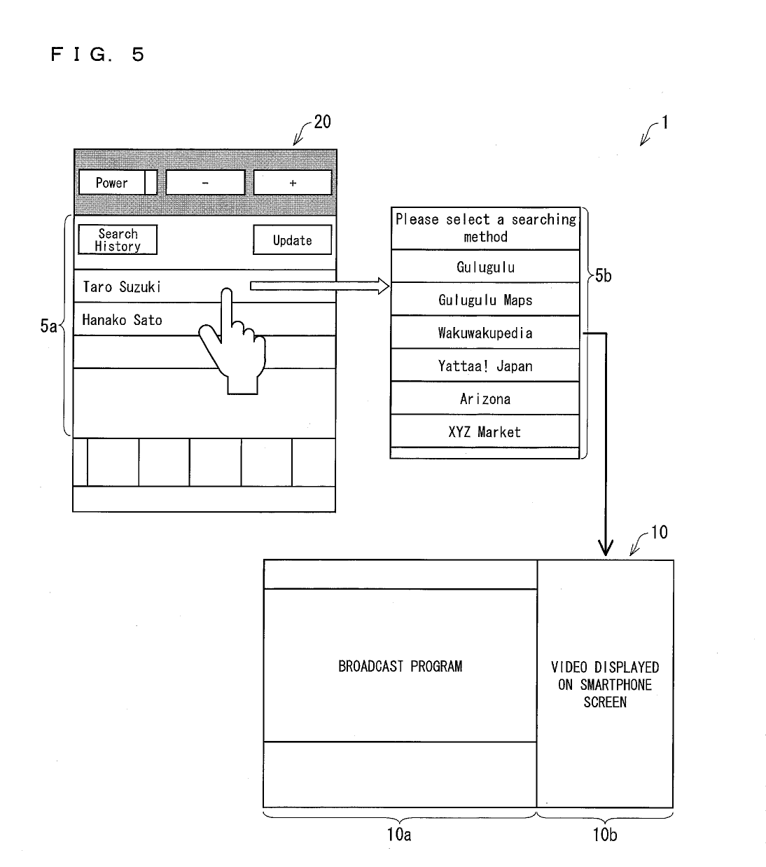

The keyword search screen will be described below with reference to FIG. 5. FIG. 5 is a view illustrating display screens of the television 10 and of the smartphone 20 in accordance with Embodiment 1, which display screens display keywords. As illustrated in FIG. 5, the screen of the smartphone 20 displays, in the step S28, a keyword search screen 5a on which the keywords are displayed in a selectable manner. The keywords on the keyword search screen 5a (“Taro Suzuki” and “Hanako Sato” in FIG. 5) are displayed in a selectable manner. In addition, a left region 10a on a left-hand side of the screen of the television 10 displays the broadcast program received by the broadcast program receiving section 11, whereas a right region 10b on a right-hand side of the screen of the television 10 displays the video which is displayed on the screen of the smartphone 20. In other words, the keyword search screen 5a displayed on the screen of the smartphone 20 is also displayed on the right region 10b.

Note that a region at which a broadcast program is to be displayed and a region at which a video displayed on the screen of the smartphone is to be displayed are not limited to these examples. The display section 17 of the television 10 thus displays, in the step S47, (i) the broadcast program and (ii) the keyword search screen which has been received by the video receiving section 15.

Note also that although persons' names are displayed as keywords in FIG. 5, the keywords are not limited to these examples.

Alternatively, it is possible that a keyword search screen 5a, which is displayed after the turning request to turn to a keyword search screen is acquired, displays a keyword(s) as illustrated in FIG. 5. In other words, it is possible that after the step S24, the step S26 instead of the step S25 is carried out.

Alternatively, it is also possible that (i) the keyword search screen 5a displayed in the step S25 does not display any keywords and (ii) tapping an “update” button illustrated in FIG. 5 causes the step S26 and subsequent steps to be carried out so that the screen of the smartphone 20 then displays the keyword search screen 5a on which keywords are displayed in a selectable manner as illustrated in FIG. 5.

The description of the flow of the process of displaying a search result carried out by the broadcast program playback system 1 will be continued below with reference to FIG. 2. After the steps S28 and S47, in a case where the user select any keyword from the keywords displayed on the display section 29, the input receiving section 24 of the smartphone 20 acquires the keyword thus selected (S29), and then supplies, to the search requesting section 26, (i) an input signal indicating that the keywords has been selected and (ii) the keyword thus selected. The input receiving section 24 also transmits the input signal to the display information acquiring section 22.

When the display information acquiring section 22 receives, from the input receiving section 24, the input signal indicating that the keyword has been selected, the display information acquiring section 22 (i) acquires, from a storage section (not illustrated), a list of search engines (search servers) intended for a search based on the keyword thus selected and then (ii) supplies, the list to the display control section 28. Then, the display control section 28 causes the supplied list of the search engines to be displayed (a) in a user-selectable format and (b) as a pop-up window on the keyword search screen (S30). Specifically, the display control section 28 causes a search engine list 5b illustrated in FIG. 5 to be displayed as a pop-up window. The display control section 28 also supplies, to the video transmitting section 31, a screen identical to the screen displayed on the display section 29. Then, the video transmitting section 31 transmits the screen to the television 10.

When the video receiving section 15 of the television 10 receives the screen on which the search engine list is displayed, the display control section 16 causes the display section 17 to display the broadcast program and the screen thus received (S48).

Then, in a case where the user selects any search engine from the listed search engines displayed on the display section 29, the input receiving section 24 of the smartphone 20 acquires the search engine thus selected (S31), and then supplies, to the search requesting section 26, (i) an input signal indicating that the search engine has been selected and (ii) the search engine thus selected.

Then, the search requesting section 26 (i) converts the keyword, which has been thus selected by the user, into a format (search query) required for search to be carried out by use of the search engine selected by the user and then (ii) sends, to the search engine selected by the user, a request that a search based on the keyword selected by the user be carried out. Specifically, the search requesting section 26 launches a browser presenting the search engine thus selected, and carries out, on the browser, a search based on the keyword selected by the user (S32).

Then, when the search result receiving section 27 receives a search result from the search engine, the search result receiving section 27 supplies, to the display control section 28, a screen of the search result (search result screen). Then, the display control section 28 causes the display section 29 to display the search result screen thus supplied from the search result receiving section 27 (S33). The display control section 28 also supplies, to the video transmitting section 31, a screen identical to the screen displayed on the display section 29. Then, the video transmitting section 31 transmits the screen to the television 10.

When the video receiving section 15 of the television 10 receives the search result screen, the display control section 16 causes the display section 17 to display the broadcast program and the screen thus received (S49).

As a result, the television 10 can display (i) a screen identical to the screen showing the result of the search based on the keyword selected by the user, which search has been carried out by the smartphone 20 with the use of the search engine selected by the user and (ii) the broadcast program.

The broadcast program playback system 1 in accordance with Embodiment 1 thus includes (i) the television 10 for receiving and displaying a broadcast program and (ii) the smartphone 20. The television 10 acquires program information concerning a broadcast program, and then transmits, to the smartphone 20, at least part of the program information. The television 10 also receives a video transmitted from the smartphone 20, and then simultaneously displays the broadcast program and the video. The smartphone 20 (i) receives the program information transmitted from the television 10, (ii) acquires predetermined display information in accordance with the program information, and then (iii) displays, on the screen thereof, the display information in a user-selectable format. The smartphone 20 also transmits, to the television 10, a video identical to a video displayed on the entire screen of the smartphone 20.

According to the configuration, the smartphone 20 (i) receives, from the television 10, at least part of the program information concerning the broadcast program displayed on the television 10 and then (ii) displays, on the screen thereof, the at least part of the program information in a user-selectable format. This allows the broadcast program playback system 1 to provide, on the screen of the television 10, a user with both (i) the broadcast program and (ii) the display information on the program information concerning the broadcast program.

The television 10 also displays the video identical to the video displayed on the entire screen of the smartphone 20. This allows the user to carry out, without moving his/her point of sight to the screen of the smartphone 20, an operation to select desired display information from display information which is displayed on the screen of the smartphone 20 by viewing the screen of the television 10. Therefore, it is possible to save the user inconvenience in comparison with a case where program information concerning a broadcast program is inputted on the screen of the smartphone 20.

In addition, the program information transmitting section 13 of the television 10 included in the broadcast program playback system 1 of Embodiment 1 transmits, to the smartphone 20, a keyword concerning the broadcast program. Then, the display information acquiring section 22 of the smartphone 20 acquires the keyword as display information. Then, in a case where the keyword is selected by the user, the smartphone 20 requests that a search based on the keyword be carried out on a search server, and then receives a search result provided from the search server. Then, the smartphone 20 (i) displays, on the screen thereof, the search result thus received and (ii) transmits, to the television 10, a video identical to a video displayed on the entire screen of the smartphone 20. Then, the television 10 displays, on the screen thereof, the video received from the smartphone 20.

According to the configuration, the television 10 (i) transmits, as at least part of the program information, the keyword concerning the broadcast program, and then (ii) displays, in a user-selectable format on the screen thereof, the keyword which the smartphone 20 received from the television 10. This allows the broadcast program playback system 1 to provide, on the screen of the television 10, a user with both (i) a broadcast program and (ii) a keyword concerning the broadcast program. In addition, the user can select, on the screen of the television 10, a keyword to be searched for without moving his/her point of sight to the screen of the smartphone 20. This eliminates the inconvenience of inputting, on the screen of the smartphone 20, a character string to be searched for, and therefore improves operability.

In the case where the keyword was selected by the user, the smartphone 20 displays, on the screen thereof, the search result provided from the search server to which a request for a search based on the keyword had been sent. The television 10 displays, on the screen thereof, the broadcast program and the search result. This allows the broadcast program playback system 1 to provide a user with, together with the broadcast program, the search result of the search based on the keyword which (i) has been selected by the user and (ii) concerns the broadcast program.

Note that although the description above discussed the program information transmitting section 13 of the television 10 extracting a keyword from a program information in the step S45, it is possible for the smartphone 20 to extract the keyword. Specifically, it is possible that (i) the program information transmitting section 13 transmits, to the smartphone 20, at least part of a program information acquired by the program information acquiring section 12, (ii) the program information receiving section 21 of the smartphone 20 receives the at least part of the program information, and then (iii) the display information acquiring section 22 extracts a keyword from the program information.

According to the configuration, it is the smartphone 20 that (i) acquires at least one keyword concerning a broadcast program from at least part of program information concerning the broadcast program being displayed on the television 10 and then (ii) displays, on the screen thereof, the at least one keyword in a user-selectable format. This allows the broadcast program playback system 1 to provide, on the screen of the television 10, a user with both (i) a broadcast program and (ii) a keyword concerning the broadcast program. In addition, the user can select, on the screen of the television 10, a keyword to be searched for without moving his/her point of sight to the screen of the smartphone 20. This eliminates the inconvenience of inputting, on the screen of the smartphone 20, a character string to be searched for, and therefore improves operability.

In the case where the keyword was selected by the user, the smartphone 20 displays, on the screen thereof, the search result provided from the search server to which a request for a search based on the keyword had been sent. The television 10 displays, on the screen thereof, the broadcast program and the search result. This allows the broadcast program playback system 1 to provide a user with, together with the broadcast program, the search result of the search based on the keyword which (i) has been selected by the user and (ii) concerns the broadcast program.

With the configuration, the user can view, on the screen of the television 10 with a simple operation, (i) information concerning a broadcast program being displayed on the television 10 and (ii) the broadcast program. Examples of the information concerning the broadcast program encompass a profile(s) of an individual(s) appearing in the broadcast program, information regarding places introduced in the broadcast program, and comments of an audience viewing the broadcast program.

(Method of Displaying Search History)

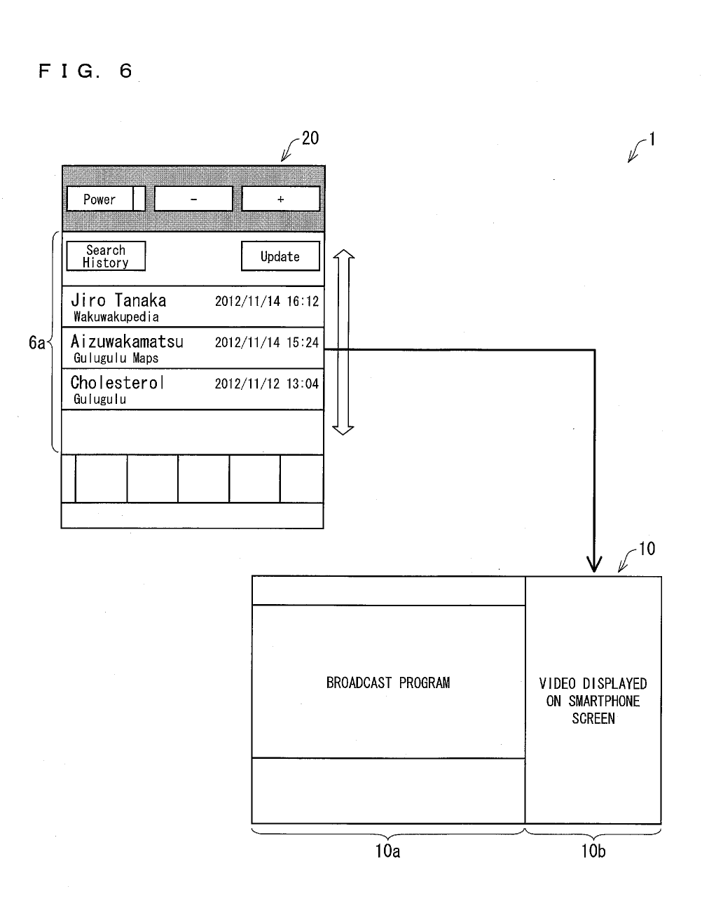

A method of displaying a search history will be described next with reference to FIG. 6. FIG. 6 is a view illustrating display screens of the television 10 and of the smartphone 20 in accordance with Embodiment 1 of the present invention, which display screens display a search history.

In a case where a “search history” button on the keyword search screen 5a illustrated in FIG. 5 is tapped, the screen of the smartphone 20 displays a search history screen 6a illustrated in FIG. 6. The search history screen 6a displays, in a selectable format, previously searched keywords (e.g. “Jiro Tanaka” illustrated in FIG. 6) together with search dates and search engines. The keyword thus displayed does not need to be related to a broadcast program.

In a case where a user selects any one of the keywords displayed on the search history screen 6a, the search requesting section 26 conducts a search (i) based on a keyword which has been selected by the user and which has been previously searched for and (ii) by use of a search engine which was used when the keyword was previously searched for. Then, when the search result receiving section 27 receives a search result from the search engine, the display control section 28 causes the display section 29 to display a search result screen. The video transmitting section 31 transmits the search result screen to the television 10. Then, the display control section 16 of the television 10 causes the display section 17 to display a broadcast program and the search result screen thus received.

Since the smartphone 20 thus displays a search history, it is possible to easily carry out a search based on a keyword on which a previous search was based.

(Modification)

Embodiment 1 described the search based on a keyword that the smartphone 20 carries out on a search server. Alternatively, the smartphone 20 can be configured to carry out, within the smartphone 20, a search based on a keyword. For example, in a case where a keyword is location information such as an address, the smartphone 20 can (i) search, by use of location information of GPS, for information on a location specified by the keyword (the information is, for example, an address included in the keyword, a photo captured in the proximity of the address or the like) and (ii) display the information.

### Embodiment 2

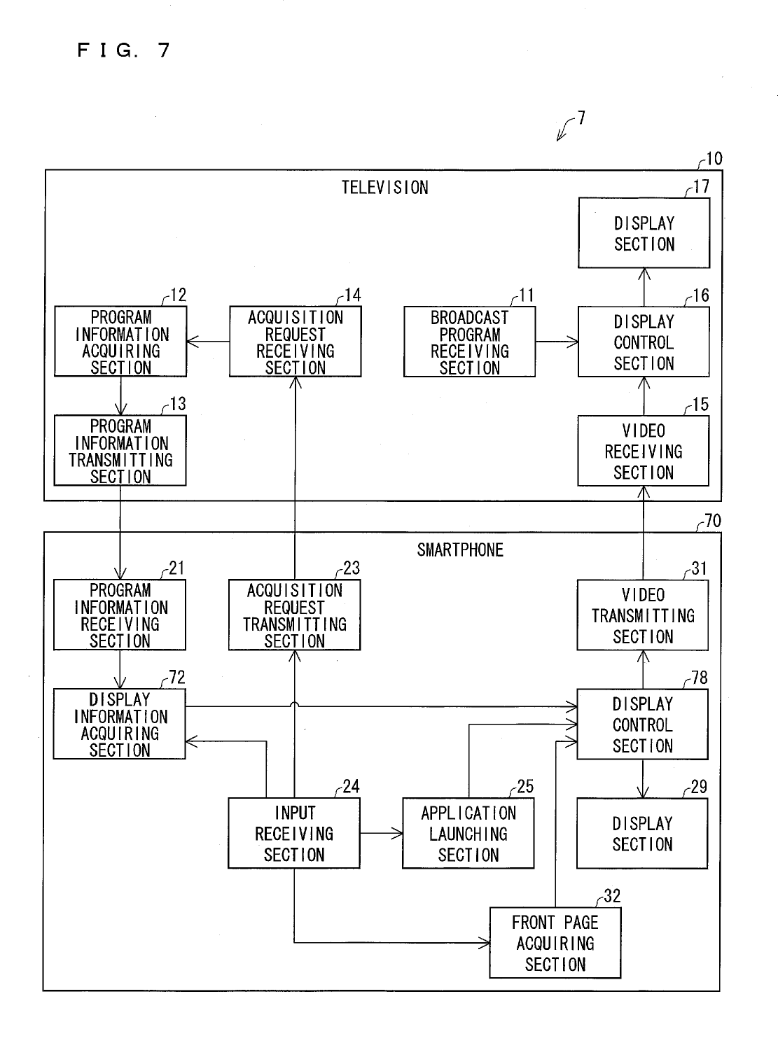

The following description will discuss another embodiment (Embodiment 2) of the present invention with reference to FIGS. 7 through 9.

(Configuration of Broadcast Program Playback System)

FIG. 7 is a block diagram illustrating a configuration of a broadcast program playback system 7 in accordance with Embodiment 2 of the present invention. Note that members identical in function to the members described in Embodiment 1 will be given the same reference signs, and their description will be omitted.

As illustrated in FIG. 7, the broadcast program playback system 7 includes (i) a television 10 for receiving and displaying a broadcast program and (ii) a smartphone (terminal device) 70. The smartphone 70 wirelessly communicates with the television 10 to operate the television 10. A technology used for the wireless communication between the smartphone 70 and the television 10 is, for example, Miracast (registered trademark), but is not limited as such. Alternatively, the smartphone 70 and the television 10 can communicate with each other via wired communication.

Although Embodiment 2 discusses a terminal device by use of a smartphone as an example, the present invention is not limited as such. For example, the terminal device can be a PDA or the like.

Furthermore, the block diagram shown in FIG. 7 depicts, of all functions of the television 10 and of the smartphone 70, functions that are unique to the present invention. Needless to say, the television 10 and the smartphone 70 are equipped with functions that are not illustrated in FIG. 7.

(Configuration of Smartphone 70)

The smartphone 70 includes a program information receiving section 21, a display information acquiring section 72, an acquisition request transmitting section 23, an input receiving section 24, an application launching section 25, a display control section (display information displaying section, home page displaying section) 78, a display section (display information displaying section, home page displaying section) 29, a video transmitting section 31 and a home page acquiring section 32.

The display information acquiring section 72 acquires predetermined display information in accordance with program information which has been received by the program information receiving section 21. Specifically, in a case where the program information received by the program information receiving section 21 is an identifier indicative of a broadcast station which provides a broadcast program, the display information acquiring section 72 acquires display information that guides a user to an official website of the broadcast station specified by the identifier. Then, the display information acquiring section 72 supplies, to the display control section 78, the display information thus acquired.

The display control section 78 causes the display section 29 to display, in a user-selectable format, the display information acquired by the display information acquiring section 72. The display control section 78 also causes the display section 29 to display a home page which has been supplied from the home page acquiring section 32. The display control section 78 also causes the display section 29 to display a display screen of an application which has been supplied from the application launching section 25. The display control section 78 also supplies, to the video transmitting section 31, a video identical to a video displayed on an entire screen of the display section 29.

In accordance with an input signal from the input receiving section 24, the home page acquiring section 32 accesses an official website associated with display information selected by the user, and then acquires a home page of the official website. Then, the home page acquiring section 32 supplies, to the display control section 78, the home page thus acquired.

(Flow of Process)

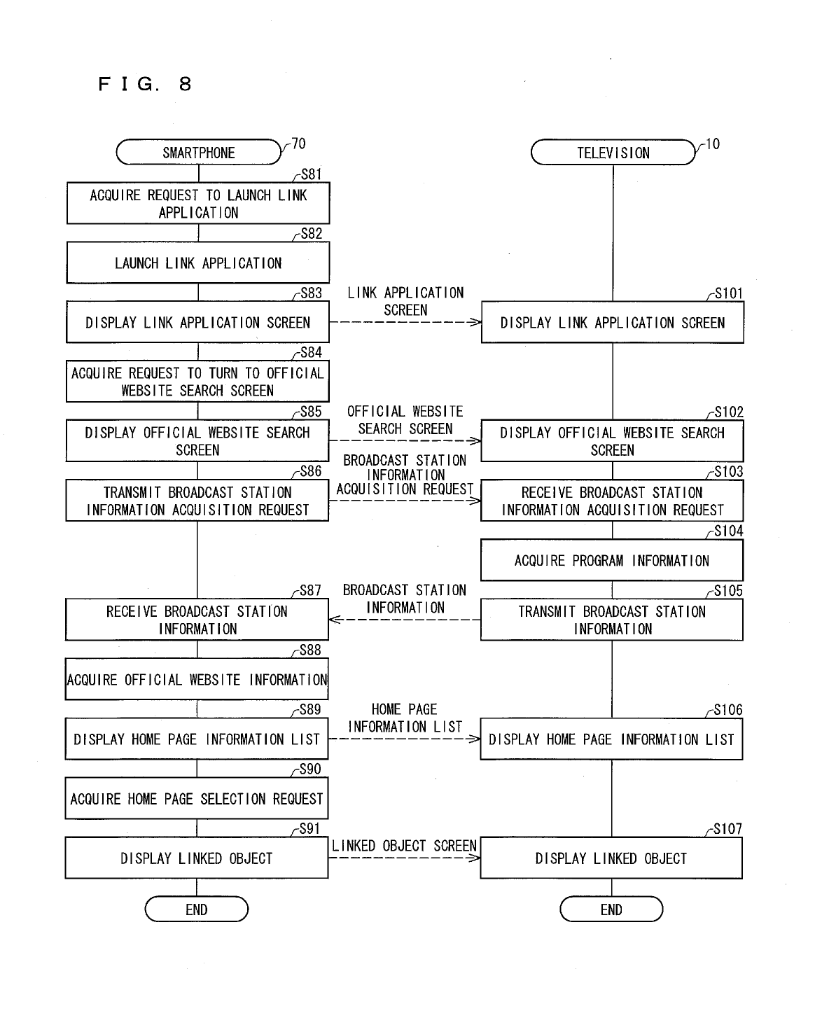

A flow of a process of the broadcast program playback system 7 will be described next with reference to FIG. 8. FIG. 8 is a flow chart illustrating a flow of a process of displaying an official website carried out by the broadcast program playback system 7 in which the television 10 simultaneously displays (i) broadcast program and (ii) a video transmitted from the smartphone 70. Note that each of broken lines shown between the respective processes of the television 10 and of the smartphone 70 in FIG. 7 indicates transmission of information from the television 10 to the smartphone 70 or vice versa.

Note also that FIG. 7 shows, as information transmitted from the smartphone 70 to the television 10, screens (e.g. link application screen) displayed on the display section 29 of the smartphone 70. In addition to such screens shown in FIG. 7, however, the smartphone 70 transmits, to the television 10, videos identical to videos displayed on the entire screen of the display section 29.

Steps S81 through S83 and S101 illustrated in FIG. 7 are identical to the steps S21 through S23 and S41 illustrated in FIG. 2, respectively, and will therefore not be described.

After the step S83, in a case where the user gives a turning request to turn to a page showing, of all the functions of the link application, an official website search function (official website search screen), the input receiving section 24 of the smartphone 70 acquires the turning request to turn to the official website search screen (S84). Then, the input receiving section 24 transmits, to the application launching section 25 and to the acquisition request transmitting section 23, an input signal indicating that the turning request to turn to the official website search screen has been acquired.

Then, the application launching section 25 supplies, to the display control section 78, the official website search screen as a display screen of the application. Then, the display control section 78 causes the display section 29 to display the official website search screen thus supplied (S85). The display control section 78 also supplies, to the video transmitting section 31, a screen identical to the official website search screen displayed on the display section 29. Then, the video transmitting section 31 transmits the screen to the television 10.

Then, when the video receiving section 15 of the television 10 receives the official website search screen, the display control section 16 causes the display section 17 to display the broadcast program and the official website search screen (S102).

When the acquisition request transmitting section 23 of the smartphone 70 receives the input signal transmitted from the input receiving section 24, the acquisition request transmitting section 23 transmits, to the television 10, a program information acquisition request. Specifically, the acquisition request transmitting section 23 transmits, as a program information acquisition request, an request (broadcast station information acquisition request) to acquire an identifier which indicates a broadcast station that provides the broadcast program (S86).

When the acquisition request receiving section 14 of the television 10 receives the broadcast station information acquisition request (S103), the acquisition request receiving section 14 gives, to the program information acquiring section 12, a notification that the broadcast station information acquisition request has been received. When the program information acquiring section 12 receives the notification, the program information acquiring section 12 acquires program information concerning the broadcast program which has been received by the broadcast program receiving section 11 (S104).

Then, the program information transmitting section 13 (i) extracts, from the program information acquired by the program information acquiring section 12 in the step S104, the identifier indicative of the broadcast station and then (ii) transmits, to the smartphone 70, broadcast station information containing the identifier (S105). Note that the program information transmitting section 13 can transmit, other than the broadcast station information, a keyword concerning the broadcast program. Examples of the keyword encompass a program name and a name(s) of an individual(s) appearing in the broadcast program.

Then, the program information receiving section 21 of the smartphone 70 receives the broadcast station information which has been transmitted from the television 10 (S87). Then, the display information acquiring section 72 acquires, as display information, information (official website information) that guides the user to an official website of the broadcast station specified by the identifier. Specifically, the display information acquiring section 72 (i) specifies the broadcast station based on the identifier indicative of the broadcast station and (ii) acquires a URL of the official website of the broadcast station, which URL is embedded in the broadcast station information containing the identifier. Alternatively, it is possible to acquire the URL of the official website of the broadcast station by searching for the broadcast station on the web. Alternatively, it is possible to acquire the URL of the official website of the broadcast station by looking up a database which exists on the cloud and which stores broadcast stations and their respective official websites' URLs such that the broadcast stations and their respective URLs are associated. Then, the display information acquiring section 72 acquires, as display information, information (e.g. the URL, an image of a home page indicated by the URL, an image into which a link to the home page is inserted, or the like) that guides the user to the official website of the broadcast station (S88).

The display information acquiring section 72 also acquires, as display information, (i) information that guides the user to, of the official website of the broadcast station, a website related to a broadcast program which is being broadcast (e.g. an official website of the broadcast program), (ii) information displayed on a page (search result screen) showing a result of search carried out for a program name of the broadcast program), or the like. Hereinafter, the display information acquired by the display information acquiring section 72, such as display information guiding the user to a website, will also be referred to as “home page information.”

The display information acquiring section 72 supplies, to the display control section 78, the home page information thus acquired. Then, the display control section 78 causes the display section 29 to display an official website search screen that contains a list (home page information list) displaying the supplied home page information in a user-selectable format (S89). The display control section 78 also supplies, to the video transmitting section 31, a screen identical to the screen displayed on the display section 29. Then, the video transmitting section 31 transmits, the screen to the television 10.

When the video receiving section 15 of the television 10 receives the official website search screen, the display control section 16 causes the display section 17 to display the broadcast program and the official website search screen (S106).

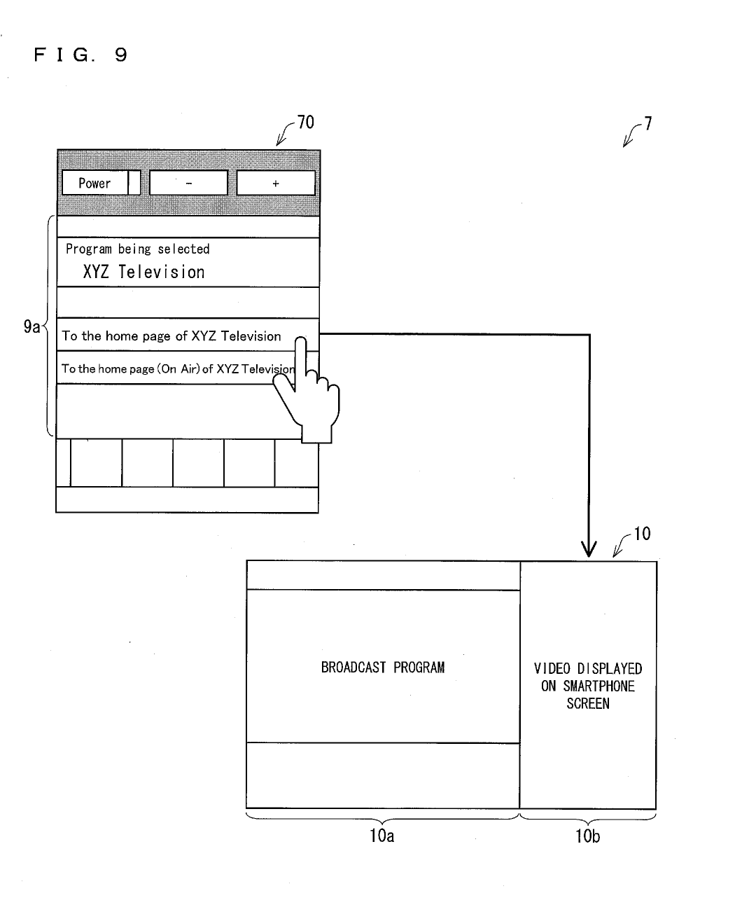

The official website search screen containing the home page information list will be described below with reference to FIG. 9. FIG. 9 is a view illustrating display screens of the television 10 and of the smartphone 70 in accordance with Embodiment 2, which display screens display home page information. As illustrated in FIG. 9, the screen of the smartphone 20 displays, in the step S89, an official website search screen 9a displaying home page information in a selectable manner. The home page information (in FIG. 9, for example, a character string “to the home page of XYZ television” into which a link to the official website is inserted) on the official website search screen 9a is displayed in a in a selectable manner. In addition, a left region 10a on a left-hand side of the screen of the television 10 displays a broadcast program received by the broadcast program receiving section 11, whereas a right region 10b on a right-hand side of the screen of the television 10 displays a video which is displayed on the screen of the smartphone 70. In other words, the home page information displayed on the screen of the smartphone 70 is also displayed on the right region 10b.

Note that a region at which a broadcast program is to be displayed and a region at which a video displayed on the screen of the smartphone is to be displayed are not limited to these examples. The display section 17 of the television 10 thus displays, in the step S106, (i) the broadcast program and (ii) the official website search screen which has been received by the video receiving section 15.

Alternatively, it is possible that an official website search screen 9a, which is displayed after the turning request to turn to an official website search screen is acquired, displays home page information as illustrated in FIG. 9. In other words, it is possible that after the step S84, the step S86 instead of the step S85 is carried out.

The description of the flow of the process of displaying a search result carried out by the broadcast program playback system 7 will be continued below with reference to FIG. 8. After the steps S89 and S106, in a case where a user selects any given home page information from the home page information list displayed on the display section 29, the input receiving section 24 of the smartphone 70 acquires the home page information thus selected (S90), and then supplies, to the home page acquiring section 32, (i) an input signal indicating that the home page information has been selected and (ii) a URL associated with the home page information thus selected.

Then, the home page acquiring section 32 accesses a website (e.g. the official website of the broadcast station) specified by the URL supplied from the input receiving section 24, and then acquires a linked object (home page). Then, the home page acquiring section 32 supplies, to the display control section 78, the home page (screen of the linked object) thus acquired. Then, the display control section 78 causes the display section 29 to display the home page thus supplied from the home page acquiring section 32 (S91). The display control section 78 also supplies, to the video transmitting section 31, a screen identical to the screen displayed on the display section 29. Then, the video transmitting section 31 transmits the screen to the television 10.

When the video receiving section 15 of the television 10 receives the screen of the linked object, the display control section 16 causes the display section 17 to display the broadcast program and the screen thus received (S107). As a result, the television 10 can display (i) the screen identical to the screen (displayed on the smartphone 70) of the home page of the website that is obtained from the home page information selected by the user and (ii) the broadcast program.

Note that although Embodiment 2 discussed the example in which a broadcast station providing a broadcast program is specified by use of an identifier, the present invention is not limited to such an example. For example, it is possible to (i) acquire location information of the smartphone 70 and then (ii) specify, in accordance with the location information and an identifier, a broadcast station providing a broadcast program.

In a case where the program information (transmitted from the television 10) on the broadcast program contains information indicative of a sponsor of the broadcast program, the smartphone 70 can (i) acquire display information that guides a user to a home page of the sponsor and (ii) display the display information.

The broadcast program playback system 7 of Embodiment 2 is thus configured as follows: The program information transmitting section 13 of the television 10 transmits, to the smartphone 70, an identifier indicative of a broadcast station that provides a broadcast program. Then, the display information acquiring section 72 of the smartphone 70 acquires, as display information, display information that guides the user to an official website of the broadcast station specified by the identifier. Then, in a case where the display information is selected by the user, the smartphone 70 (i) accesses the official website to acquire a home page of the official website and then (ii) displays the home page on the screen of the smartphone 70. Then, the smartphone 70 transmits, to the television 10, a video identical to the video displayed on the entire screen of the smartphone 70. Then, the television 10 displays, on the screen thereof, the video thus received from the smartphone 70.

According to the configuration, the television 10 (i) transmits, as at least part of the program information, the identifier indicative of the broadcast station that provides the broadcast program, and then (ii) displays, in a user-selectable format on the screen of the television 10, the display information that guides the user to the official website of the broadcast station specified by the identifier which the smartphone 70 received from the television 10. This allows the broadcast program playback system 7 to provide, on the screen of the television 10, a user with both (i) a broadcast program and (ii) display information that guides the user to an official website of a broadcast station of the broadcast program. In addition, the user can carry out, on the screen of the television 10, an operation to access the official website of the broadcast station by selecting the display information without moving his/her point of sight to the screen of the smartphone 70. This eliminates the inconvenience of searching, on the screen of the smartphone 20, for the official website of the broadcast station, and therefore improves operability.

In the case where the display information is selected by the user, the smartphone 70 accesses the official website to acquire a home page of the official website, and then displays, on the screen thereof, the home page thus acquired. Then, the television 10 displays the broadcast program and the home page on the screen thereof. This allows the broadcast program playback system 7 to provide a user with (i) an official home page selected by the user and (ii) a broadcast program.

Although an official website has been discussed in the above description, a website is not limited to “official” ones. In fact, the website can be unofficial or private ones, provided that the website supplies information similar to that supplied by an official website. In other words, the website only needs to be a website related to a broadcast station.

### Embodiment 3

(Operation in Coordination with Viewing Information)

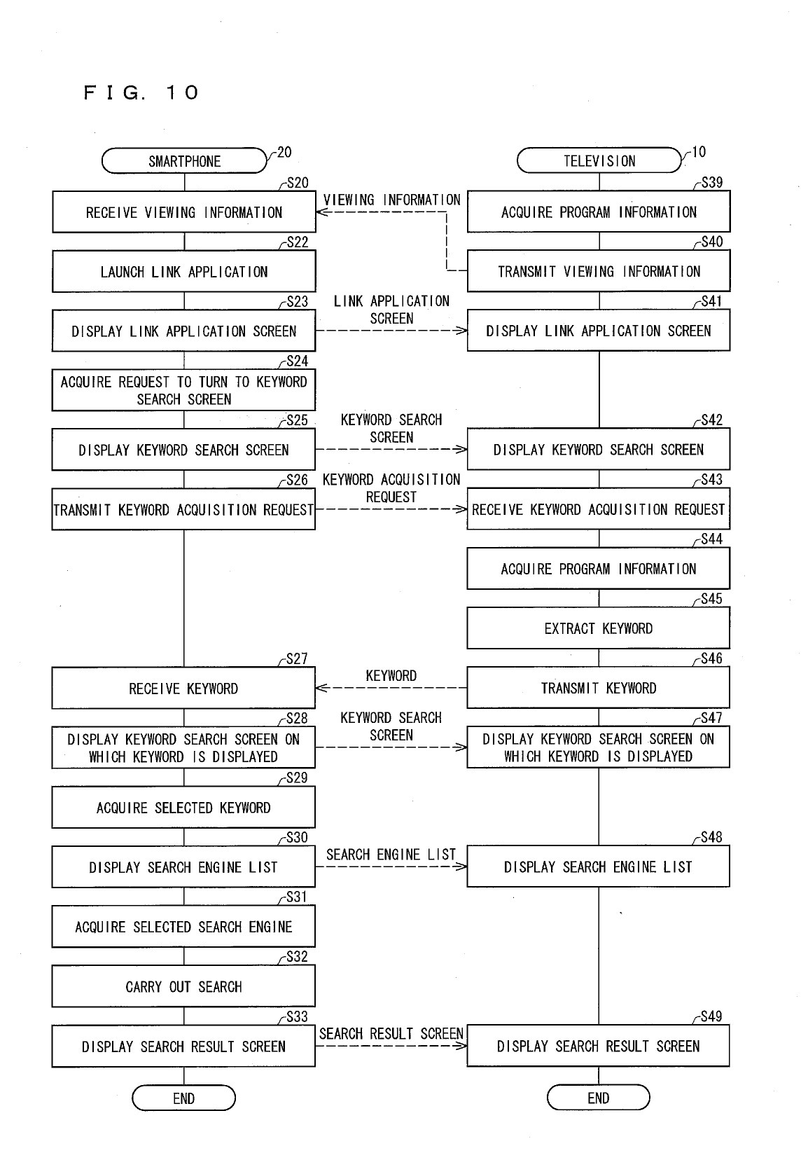

According to Embodiments 1 and 2, a user's request to launch a link application causes the link application to be launched in the smartphone 20. However, the present invention is not necessarily limited to such an example. For example, it is possible that while a user is viewing a broadcast program, the smartphone 20 automatically launches a link application and carries out a process of displaying a search result as described in Embodiment 1. The following description will discuss, with reference to FIG. 10, a flow of a process carried out by a broadcast program playback system 1 in a case where a link application is to be automatically launched while a user is viewing a broadcast program. FIG. 10 is a flow chart illustrating a flow of a process of displaying a search result carried out by the broadcast program playback system 1 in which a television 10 simultaneously displays (i) a broadcast program and (ii) a video transmitted from a smartphone 20. Note that each of broken lines shown between the respective processes of the television 10 and of the smartphone 20 in FIG. 10 indicates transmission of information from the television 10 to the smartphone 20 or vice versa.

As illustrated in FIG. 10, while the television 10 is simultaneously displaying the broadcast program and the video which has been transmitted from the smartphone 20, a program information acquiring section 12 of the television 10 acquires program information concerning the broadcast program received by a broadcast program receiving section 11 (S39). Then, a program information transmitting section 13 (i) extracts, from the program information acquired by the program information acquiring section 12 in the step S39, information (viewing information) on a “broadcast station being viewed” and a “name of the broadcast program being viewed” and (ii) transmits the viewing information to the smartphone 70 (S40). Note that the information on the “broadcast station being viewed,” which information is transmitted by the program information transmitting section 13, is more specifically (i) information on the broadcast station providing the broadcast program received by the broadcast program receiving section 11 and (ii) information containing an identifier (service ID) indicative of a network type (digital terrestrial broadcasting, BS broadcasting and CS broadcasting) and of the broadcast station.

Then, when a program information receiving section 21 of the smartphone 70 receives the viewing information (S20), the program information receiving section 21 supplies, to the application launching section 25, an input signal indicating that the viewing information has been received. When the application launching section 25 receives the input signal, the application launching section 25 (i) specifies the broadcast station in accordance with the identifier contained in the viewing information and (ii) launches a link application of the broadcast station thus specified (S22). The “link application of the broadcast station” refers to an application associated with the broadcast station (e.g. official application of the broadcast station). In other words, the link application of the broadcast station is an application associated with the viewing information received. Other details of the link application are, for example, as described in Embodiment 1.

A step S23 and subsequent steps and a step S42 and subsequent steps illustrated in FIG. 10 are identical to the step S23 and the subsequent steps and the step S42 and the subsequent steps illustrated in FIG. 2, respectively, and will therefore not be described.

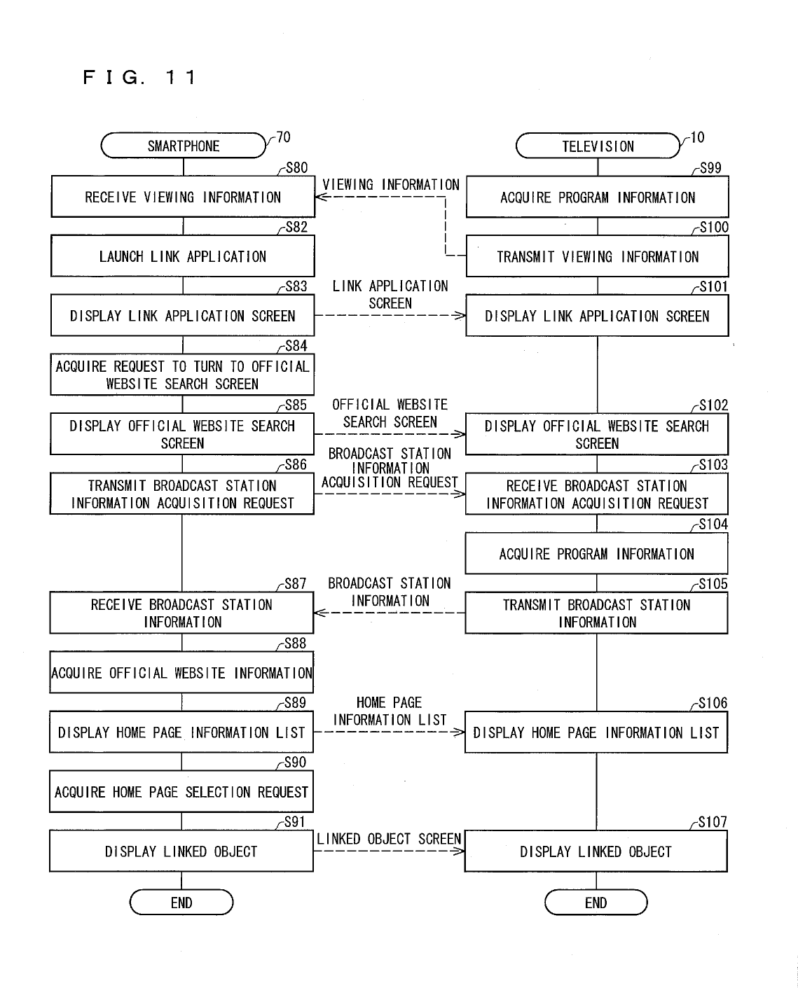

Alternatively, it is possible that while a user is viewing a broadcast program, the smartphone 20 automatically launches a link application and carries out the process of displaying an official website as described in Embodiment 2. The following description will discuss, with reference to FIG. 11, a flow of a process carried out by a broadcast program playback system 1 in a case where a link application is to be automatically launched while a user is viewing a broadcast program. FIG. 11 is a flow chart illustrating a flow of a process of displaying an official website carried out by the broadcast program playback system 1 in which a television 10 simultaneously displays (i) a broadcast program and (ii) a video transmitted from a smartphone 20. Note that each of broken lines shown between the respective processes of the television 10 and of the smartphone 20 in FIG. 11 indicates transmission of information from the television 10 to the smartphone 20 or vice versa.

As illustrated in FIG. 11, while the television is simultaneously displaying a broadcast program and a video which has been transmitted from the smartphone 20, a program information acquiring section 12 of the television 10 acquires program information concerning the broadcast program received by the broadcast program receiving section 11 (S99). Then, a program information transmitting section 13 (i) extracts viewing information from the program information acquired by the program information acquiring section 12 in the step S99 and then (ii) transmits the viewing information to the smartphone 70 (S100). Then, when a program information receiving section 21 of the smartphone 70 receives the viewing information (S80), the program information receiving section 21 supplies, to the application launching section 25, an input signal indicating that the viewing information has been received. When the application launching section 25 receives the input signal, the application launching section 25 (i) specifies the broadcast station in accordance with an identifier contained in the viewing information and (ii) launches a link application of the broadcast station thus specified (S82).

A step S83 and subsequent steps and a step S101 and subsequent steps illustrated in FIG. 11 are identical to the step S83 and the subsequent steps and the step S101 and the subsequent steps illustrated in FIG. 2, respectively, and will therefore not be described.

The program information acquiring section 12 can, for example, acquire program information (viewing information) (i) at a timing at which a broadcast program is changed or (ii) at a predetermined timing (e.g. at predetermined intervals). Note that examples of a timing at which a broadcast program is changed encompass (i) a timing at which a user selects a channel displayed on the television 10 and (ii) a timing at which a broadcast program is switched from one that ended to a next one.

In a case where the program information acquiring section 12 acquires the program information of the broadcast program at a timing at which the broadcast program is changed or at a predetermined timing, the application launching section 25 launches a link application. Since the link application is launched automatically without a user's request to launch the link application, it is possible to save the user inconvenience. In particular, since the link application of the broadcast station of the broadcast program is launched, it is possible to use an application provided by a broadcast station.

As has been made clear by the description above, the configuration described in Embodiment 3 can be described as a configuration in which: the terminal device (smartphone 70) further includes a launch control section (application launching section 25) for controlling launching of an application (link application) that controls the display information acquiring section 22 and the display information displaying section (display control section 28); the program information acquiring section 22 acquires, at a timing at which a broadcast program to be received by the broadcast program playback device (television 10) is changed or at a predetermined timing, program information concerning a broadcast program; the program information transmitting section 13 transmits, to the terminal device, at least part of the program information thus acquired by the program information acquiring section; and the launch control section launches the application when the program information receiving section 21 receives the program information.

(Acquisition of Keyword Concerning Recorded Program)

Although a keyword contained in program information of a broadcast program is acquired in the description above, the present invention is not limited to such an example. For example, it is possible to acquire a keyword contained in program information on a broadcast program (recorded program) recorded by the television 10. In such a case, when the television 10 records a broadcast program, the program information acquiring section 12 (i) acquires program information on the broadcast program and (ii) causes the program information and broadcast program data to be stored in a storage section (not illustrated) of television 10. In a case where a user gives a turning request to turn to a keyword search function page while viewing a recorded program, the program information acquiring section 12 acquires, from the storage section, program information concerning the recorded program. Then, in a case where (i) the program information transmitting section 13 transmits, as at least part of the program information acquired by the program information acquiring section 12, a keyword concerning the recorded program and (ii) the program information receiving section 21 receives the keyword, the display information acquiring section 22 acquires the keyword as display information. In a case where program information received by the program information receiving section 21 is at least part of the program information acquired by the program information acquiring section 12, the display information acquiring section 22 acquires at least one keyword which is contained in the program information received by the program information receiving section 21 and which concerns the recorded program. This allows the user to carry out a search based on the keyword contained in the program information on the recorded program. Since the recorded program is a program that has already been broadcast, the user can obtain information such as (i) comments on the program which are posted on the Internet, (ii) an amount of reactions of viewers to the program (i.e. enthusiasm level), (iii) crucial information regarding the ending of the program (i.e. spoiler), or the like. For example, the above configuration is suitable for obtaining these pieces of information before viewing the recorded program.

Alternatively, the recorded program can be recorded by an external recorder (memory device) connected to the television 10 via DLNA (Digital Living Network Alliance; registered trademark) or the like. In such a case, the program information acquiring section 12 of the television 10 (i) acquires program information on a broadcast program and (ii) causes the program information and broadcast program data to be stored in a storage section of the recorder. Assume a case where the recorder is not particularly intended for the configuration of the present invention. Even in such a case, unless program information is deleted during recording, the television 10 can acquire the program information from the recorder by a normal playback process. This is because program information on a broadcast program is superimposed in a broadcast stream during broadcasting. Therefore, even in a case of a recorded program recorded in a recorder, it is possible to carry out a search based on a keyword contained in program information if the program information is available.

Note that a user can, while viewing a recorded program, search for a website related to a broadcast station of the recorded program. In such a case, the following is true: In a case where the user gives a turning request to turn to a function page on which to search for an official website, the program information acquiring section 12 acquires, from the storage section, program information concerning the recorded program. Then, the program information transmitting section 13 (i) extracts, from the program information acquired by the program information acquiring section 12, an identifier indicative of the broadcast station and (ii) transmits, to the program information receiving section 21, broadcast station information containing the identifier. Then, the display information acquiring section 72 acquires, as display information, information guiding the user to an official website of the broadcast station which is specified by the identifier contained in the program information.

### Software Implementation Example

Blocks of the television 10, smartphone 20 and smartphone 70 may be realized by a logic circuit (hardware) provided in an integrated circuit (IC chip) or the like or may be realized by software as executed by a CPU (Central Processing Unit).

In the case where each of the control blocks is configured by software, each of the television 10, smartphone 20 and smartphone 70 includes: a CPU that executes requests of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

The embodiments and the concrete examples, which have been discussed in the detailed description, are illustrative only, which should not be narrowly interpreted within the limits of such embodiments and concrete examples, but are rather meant to be applied in any variations within the spirit of the present invention, provided that such variations do not exceed the scope of the patent claims set forth below.

### Summary

A broadcast program playback system in accordance with Aspect 1 of the present invention includes: a broadcast program playback device (television 10) for receiving and displaying a broadcast program; and a terminal device (smartphone 20, smartphone 70), the broadcast program playback device including a program information acquiring section (program information acquiring section 12) for acquiring program information concerning the broadcast program, a program information transmitting section (program information transmitting section 13) for transmitting, to the terminal device, at least part of the program information, a video receiving section (video receiving section 15) for receiving a video transmitted from the terminal device, and a displaying section (display control section 16, display section 17) for simultaneously displaying the broadcast program and the video, and the terminal device including a video transmitting section (video transmitting section 31) for transmitting, to the broadcast program playback device, the video identical to a video displayed on an entire part of a screen of the terminal device, a program information receiving section (program information receiving section 21) for receiving the program information transmitted from the broadcast program playback device, a display information acquiring section (display information acquiring section 22, display information acquiring section 72) for acquiring predetermined display information in accordance with the program information, and a display information displaying section (display control section 28, display control section 78, display section 29) for displaying, on the screen, the predetermined display information in a format allowing a user to make selection.

According to the configuration, the terminal device (i) receives, from the broadcast program playback device, at least part of the program information concerning the broadcast program displayed on the broadcast program playback device and (ii) displays, on the screen thereof, the at least part of the program information in a user-selectable format. This allows the broadcast program playback system to provide, on the screen of the broadcast program playback device, a user with both (i) a broadcast program and (ii) display information on program information concerning the broadcast program.

In addition, the broadcast program playback device thus displays a video identical to a video displayed on the entire screen of the terminal device. This allows the user to carry out, without moving his/her point of sight to the screen of the terminal device, an operation to select desired display information from display information which is displayed on the screen of the terminal device by viewing the screen of the broadcast program playback device. Therefore, it is possible to save the user inconvenience.

The broadcast program playback system in accordance with Aspect 2 of the present invention can be configured in Aspect 1 such that: the program information transmitting section transmits, as the at least part of the program information, a keyword concerning the broadcast program; the display information acquiring section acquires, as the predetermined display information, the keyword received by the program information receiving section; and the terminal device further includes a search requesting section (search requesting section 26) for giving, in a case where the keyword is selected by the user, a search server a request that a search based on the keyword be carried out, a search result receiving section (search result receiving section 27) for receiving a search result provided by the search server, and a search result displaying section (display control section 28, display section 29) for displaying the search result on the screen.

According to the configuration, the broadcast program playback device (i) transmits, as at least part of the program information, the keyword concerning the broadcast program, and then (ii) displays, in a user-selectable format on the screen thereof, the keyword which the terminal device received from the broadcast program playback device. This allows the broadcast program playback system to provide, on the screen of the broadcast program playback device, a user with both (i) a broadcast program and (ii) a keyword concerning the broadcast program. In addition, the user can select, on the screen of the broadcast program playback device, a keyword to be searched for without moving his/her point of sight to the screen of the terminal device. This eliminates the inconvenience of inputting, on the screen of the terminal device, a character string to be searched for, and therefore improves operability.

In the case where the keyword was selected by the user, the terminal device displays, on the screen thereof, the search result provided from the search server to which a request for a search based on the keyword had been sent. The broadcast program playback device displays, on the screen thereof, the broadcast program and the search result. This allows the broadcast program playback system to provide a user with, together with the broadcast program, the search result of the search based on the keyword which (i) has been selected by the user and (ii) concerns the broadcast program.

The broadcast program playback system in accordance with Aspect 3 of the present invention can be configured in Aspect 1 such that: the display information acquiring section acquires, as the predetermined display information, at least one keyword which is contained in the program information and which concerns the broadcast program; and the terminal device further includes a search requesting section (search requesting section 26) for giving, in a case where the keyword is selected by the user, a search server a request that a search based on the keyword be carried out, a search result receiving section (search result receiving section 27) for receiving a search result provided by the search server, and a search result displaying section (display control section 28, display section 29) for displaying the search result on the screen.

According to the configuration, it is the terminal that (i) acquires at least one keyword concerning a broadcast program from at least part of program information concerning the broadcast program being displayed on the terminal device and then (ii) displays, on the screen thereof, the at least one keyword in a user-selectable format. This allows the broadcast program playback system to provide, on the screen of the broadcast program playback device, a user with both (i) a broadcast program and (ii) a keyword concerning the broadcast program. In addition, the user can select, on the screen of the broadcast program playback device, a keyword to be searched for without moving his/her point of sight to the screen of the terminal device. This eliminates the inconvenience of inputting, on the screen of the terminal device, a character string to be searched for, and therefore improves operability.

In the case where the keyword was selected by the user, the terminal device displays, on the screen thereof, the search result provided from the search server to which a request for a search based on the keyword had been sent. The broadcast program playback device displays, on the screen thereof, the broadcast program and the search result. This allows the broadcast program playback system to provide a user with, together with the broadcast program, the search result of the search based on the keyword which (i) has been selected by the user and (ii) concerns the broadcast program.

The broadcast program playback system in accordance with Aspect 4 of the present invention can be configured in Aspects 1 through 3 such that: the program information transmitting section transmits, as the program information, an identifier which specifies a broadcast station providing the broadcast program; the display information acquiring section acquires, as the predetermined display information, information which guides the user to a website related to the broadcast station specified by the identifier; and the terminal device further includes a home page acquiring section (home page acquiring section 32) for accessing, in a case where the predetermined display information is selected by the user, the website so as to acquire a home page of the website and a home page displaying section (display control section 78, display section 29) for displaying the home page on the screen.

According to the configuration, the broadcast program playback device (i) transmits, as at least part of the program information, the identifier indicative of the broadcast station that provides the broadcast program, and then (ii) displays, in a user-selectable format on the screen thereof, the display information that guides the user to the website of the broadcast station specified by the identifier which the terminal device received from the broadcast program playback device. This allows the broadcast program playback system to provide, on the screen of the broadcast program playback device, a user with both (i) a broadcast program and (ii) display information that guides the user to a website of a broadcast station of the broadcast program. In addition, the user can carry out, on the screen of the broadcast program playback device, an operation to access the website of the broadcast station by selecting the display information without moving his/her point of sight to the screen of the terminal device. This eliminates the inconvenience of searching, on the screen of the terminal device, for the website of the broadcast station, and therefore improves operability.

In the case where the display information is selected by the user, the terminal device accesses the website to acquire a home page of the website, and then displays, on the screen thereof, the home page thus acquired. Then, the broadcast program playback device displays the broadcast program and the home page on the screen thereof. This allows the broadcast program playback system to provide a user with (i) a home page selected by the user and (ii) a broadcast program.

The broadcast program playback system in accordance with Aspect 5 of the present invention can be configured in Aspects 1 through 4 such that: the terminal device further includes a launch control section (application launching section 25) for controlling launching of an application that controls the display information acquiring section and the display information displaying section; the program information acquiring section acquires, at a timing at which a broadcast program to be received by the broadcast program playback device is changed or at a predetermined timing, program information concerning a broadcast program; the program information transmitting section transmits, to the terminal device, at least part of the program information thus acquired by the program information acquiring section; and the launch control section launches the application when the program information receiving section receives the program information.

According to the configuration, in a case where the program information acquiring section acquires program information at a timing at which a broadcast program is changed or at a predetermined timing, it is possible to automatically display, in accordance with the program information, predetermined display information in a user-selectable format on the screen of the terminal device.

The broadcast program playback system in accordance with Aspect 6 of the present invention can be configured in Aspects 1 through 5 such that: the broadcast program playback device further displays a recorded broadcast program recorded by the broadcast program playback device or by an external memory device; and the program information acquiring section further acquires program information concerning the recorded broadcast program recorded by the broadcast program playback device or by the external memory device.

According to the configuration, even in a case of a recorded program recorded by the broadcast program playback device or the external memory device, it is possible, if program information is available, to (i) carry out a search based on a keyword contained in the program information or (ii) search for a website related to a broadcast station of the recorded program.

A broadcast program playback device in accordance with Aspect 7 of the present invention is a broadcast program playback device for receiving and displaying a broadcast program, including: a program information acquiring section for acquiring program information concerning the broadcast program; a program information transmitting section for transmitting, to a terminal device, at least part of the program information; a video receiving section for receiving a video which has been transmitted from the terminal device and which is displayed on an entire part of a screen of the terminal device in a format allowing a user to make selection; and a displaying section for simultaneously displaying the broadcast program and the video.

A terminal device in accordance with Aspect 8 of the present invention is a terminal device for communicating with a broadcast program playback device that receives and displays a broadcast program, including: a video transmitting section for transmitting, to the broadcast program playback device, a video identical to a video displayed on an entire part of a screen of the terminal device; a program information receiving section for receiving program information concerning the broadcast program, which program information has been transmitted from the broadcast program playback device; a display information acquiring section for acquiring predetermined display information in accordance with the program information; and a display information displaying section for displaying, on the screen, the predetermined display information in a format allowing a user to make selection.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention. Furthermore, a new technical feature can be obtained by a combination of technical means disclosed in the different embodiments.

### INDUSTRIAL APPLICABILITY

The present invention can be used for a broadcast program playback system such as a television receiver and for a terminal device capable of communicating with a broadcast program playback system.

### REFERENCE SIGNS LIST

1 Broadcast program playback system
10 Television (television receiver, broadcast program playback device)
11 Broadcast program receiving section
12 Program information acquiring section
13 Program information transmitting section
14 Acquisition request receiving section
15 Video receiving section
16 Display control section (displaying section)
17 Display section (displaying section)
20 Smartphone (terminal device)
21 Program information receiving section
22 Display information acquiring section
23 Acquisition request transmitting section
24 Input receiving section
25 Application launching section (launch control section)
26 Search requesting section
27 Search result receiving section
28 Display control section (display information displaying section, search result displaying section)
29 Display section (display information displaying section, search result displaying section, home page displaying section)
31 Video transmitting section
7 Broadcast program playback system
72 Display information acquiring section
78 Display control section (display information displaying section, home page displaying section)
32 Home page acquiring section

1. A broadcast program playback system comprising:
a broadcast program playback device for receiving and displaying a broadcast program; and
a terminal device,
the broadcast program playback device including
a program information acquiring section for acquiring program information concerning the broadcast program,
a program information transmitting section for transmitting, to the terminal device, at least part of the program information,
a video receiving section for receiving a video transmitted from the terminal device, and
a displaying section for simultaneously displaying the broadcast program and the video, and
the terminal device including
a video transmitting section for transmitting, to the broadcast program playback device, the video identical to a video displayed on an entire part of a screen of the terminal device,
a program information receiving section for receiving the program information transmitted from the broadcast program playback device,
a display information acquiring section for acquiring predetermined display information in accordance with the program information, and
a display information displaying section for displaying, on the screen, the predetermined display information in a format allowing a user to make selection.

2. The broadcast program playback system as set forth in claim 1, wherein:
the program information transmitting section transmits, as the at least part of the program information, a keyword concerning the broadcast program;
the display information acquiring section acquires, as the predetermined display information, the keyword received by the program information receiving section; and
the terminal device further includes
a search requesting section for giving, in a case where the keyword is selected by the user, a search server a request that a search based on the keyword be carried out,
a search result receiving section for receiving a search result provided by the search server, and
a search result displaying section for displaying the search result on the screen.

3. The broadcast program playback system as set forth in claim 1, wherein:
the display information acquiring section acquires, as the predetermined display information, at least one keyword which is contained in the program information and which concerns the broadcast program; and
the terminal device further includes
a search requesting section for giving, in a case where the keyword is selected by the user, a search server a request that a search based on the keyword be carried out,
a search result receiving section for receiving a search result provided by the search server, and
a search result displaying section for displaying the search result on the screen.

4. The broadcast program playback system as set forth in claim 1, wherein:
the program information transmitting section transmits, as the program information, an identifier which specifies a broadcast station providing the broadcast program;
the display information acquiring section acquires, as the predetermined display information, information which guides the user to a website related to the broadcast station specified by the identifier; and
the terminal device further includes
a home page acquiring section for accessing, in a case where the predetermined display information is selected by the user, the website so as to acquire a home page of the website and
a home page displaying section for displaying the home page on the screen.

5. The broadcast program playback system as set forth in claim 1, wherein:
the terminal device further includes
a launch control section for controlling launching of an application that controls the display information acquiring section and the display information displaying section;
the program information acquiring section acquires, at a timing at which a broadcast program to be received by the broadcast program playback device is changed or at a predetermined timing, program information concerning a broadcast program;
the program information transmitting section transmits, to the terminal device, at least part of the program information thus acquired by the program information acquiring section; and
the launch control section launches the application when the program information receiving section receives the program information.

6. The broadcast program playback system as set forth in claim 1, wherein:
the broadcast program playback device further displays a recorded broadcast program recorded by the broadcast program playback device or by an external memory device; and
the program information acquiring section further acquires program information concerning the recorded broadcast program recorded by the broadcast program playback device or by the external memory device.

7. A broadcast program playback device for receiving and displaying a broadcast program, comprising:
a program information acquiring section for acquiring program information concerning the broadcast program;
a program information transmitting section for transmitting, to a terminal device, at least part of the program information;
a video receiving section for receiving a video which has been transmitted from the terminal device and which is displayed on an entire part of a screen of the terminal device in a format allowing a user to make selection; and
a displaying section for simultaneously displaying the broadcast program and the video.

8. A terminal device for communicating with a broadcast program playback device that receives and displays a broadcast program, comprising:
a video transmitting section for transmitting, to the broadcast program playback device, a video identical to a video displayed on an entire part of a screen of the terminal device;
a program information receiving section for receiving program information concerning the broadcast program, which program information has been transmitted from the broadcast program playback device;
a display information acquiring section for acquiring predetermined display information in accordance with the program information; and
a display information displaying section for displaying, on the screen, the predetermined display information in a format allowing a user to make selection.
